(19) United States
(12) Patent Application Publication
(10) Pub. No.: US 2016/0359186 A1
(43) Pub. Date: Dec. 8, 2016

(54) Method of Direct Electrochemical Oxidation For Modifying Carbon Felts of Flow Battery

(71) Applicant: Institute of Nuclear Energy Research, Atomic Energy Council, Executive Yuan, R.O.C., Taoyuan City (TW)

(72) Inventors: Ning-Yih Hsu, Keelung City (TW); Yi-Sin Chou, New Taipei City (TW); Heng-Wei Chiang, New Taipei City (TW); Yuan-Ming Chang, New Taipei City (TW); Kuan-Hsiang Chen, Taichung City (TW); Yu-Chun Chen, Pingtung County (TW); Hwa-Jou Wei, Taoyuan City (TW)

(21) Appl. No.: 14/732,873

(22) Filed: Jun. 8, 2015

(51) Int. Cl. H01M 8/18; H01M 8/20

(52) U.S. Cl. CPC H01M 8/188; H01M 8/20

(57) ABSTRACT

A method of direct electrochemical oxidation is provided to modify carbon felts of a flow battery. Redox reactions are used for modification. Therein, voltage is directly conducted to the cell stack. The carbon felts of the cell stack are uniformly contacted with electrolytes for processing electrochemical reactions. As a result, modification is done to generate oxygen-containing functional groups (—COOH, —OH) on surfaces of the carbon felts. Thus, the present invention has the following advantages: Operation and procedure are easy and quick. Experimental parameters and conditions can be easily regulated and replaced without dismantling a device used for modification. The device used can withstand a wide range of voltage and current. Modification effect can be obtained with low cost yet without high-temperature treatments.

### TECHNICAL FIELD OF THE INVENTION

The present invention relates to modifying carbon felts of a flow battery; more particularly, relates directly conducting voltage to process redox reactions in a cell stack with carbon felts uniformly contacted with electrolytes to generate oxygen-containing functional groups on surfaces of the carbon felts thus modified, where the present invention has a simple and fast operation with easily regulated experimental parameters and conditions without re-dismantling a device used for the modification; the device used can sustain a wide range of voltage and current; and modification effect can be obtained with low cost yet without high-temperature treatment.

### DESCRIPTION OF THE RELATED ART

Electrochemical flow battery, also known as redox flow battery, is an electrochemical energy storage device. Therein, all-vanadium (V) redox flow battery uses vanadium salt solutions as anode and cathode. The all-V redox flow battery becomes an ideal green energy storage device for its excellent charge and discharge performance, long recycling life and low cost, while their manufacture, usage and wasting process do not produce harmful substances.

Generally, as shown in FIG. 4, electrochemical reactions are processed with three-polar electrodes while voltage is conducted for redox reactions, which comprises the following steps:

Step s21: An unmodified carbon felt is used as an anode and a titanium (or graphite) plate as a cathode with an electrolyte of an aqueous solution of 1 M sulfuric acid to be conducted with voltage or current for electrochemical oxidations.

Step s22: The reactions are processed for several minutes to one hour.

Step s23: After being washed with deionized water, vacuum dry is processed at a temperature of 120 Celsius degrees (° C.) for 5 hours.

Step s24: A cell stack is thus assembled with the electrode materials.

Step s25: An aqueous solution of 1 M to 3 M vanadyl sulfate and another aqueous solution of 1 M to 5 M sulfuric acid (or hydrochloric acid or nitric acid or phosphoric acid) are pumped into the cell stack as electrolytes through an anode inlet and a cathode inlet to be uniformly contacted with the carbon felts under a flow rate controlled between 20 and 100 milli-liters per minute (mL/min). After being collected in electrolyte reservoirs through an anode outlet and a cathode outlet, the electrolytes are recycled to the anode inlet and the cathode inlet to be pumped into the cell stack until air in the cell stack is completely exhausted.

Step s26: The anode and the cathode are connected with an external power supply to be conducted with current in a constant current mode for processing charge and discharge reactions in the cell stack of a flow battery, where the charge and discharge reactions are repeated constantly.

However, the prior art uses noble metal titanium plate, which is high-cost electrode material. Moreover, a long time (about 6 hours) is required to fabricate a single cell through the above step s21 to step s23. If the cell stack is assembled with 10 single cells, the above steps have to be repeated 10 times, which quite takes time. Because the prior art only applies to single cell, each single cell obtained through the repeated steps may be easily affected by external factors and result in bad consistency. Namely, the prior art is complex and is hard to be commercialized. In addition, conventional electro-chemical oxidation can not sufficiently make the carbon felts fully contacted with the electrolytes. It is because, when the carbon felts are immersed in the electrolytes, by-reactions may happen. The electrolytes may generate bubbles of hydrogen, oxygen, etc. on electrode surface. Since the carbon felts are made of porous materials, some areas may be not uniformly contacted with the electrolytes for processing electrochemical reactions and, therefore, efficiency of the flow battery can not be effectively improved.

Hence, the prior art does not fulfill all users' requests on actual use.

### SUMMARY OF THE INVENTION

The main purpose of the present invention is to directly conduct voltage to process redox reactions in a cell stack with carbon felts uniformly contacted with electrolytes to generate oxygen-containing functional groups (—COOH, —OH) on surfaces of the carbon felts thus modified.

Another purpose of the present invention is to modify carbon felts by using a simple and fast operation with easily regulated and replaced experimental parameters and conditions without re-dismantling a device used for the modification; the device used can sustain a wide range of voltage and current; and modification effect can be obtained with low cost yet without high-temperature treatment.

Another purpose of the present invention is to increase efficiency of a battery (Coulomb efficiency, energy efficiency and voltage efficiency) through a modification method of direct electrochemical oxidation.

Another purpose of the present invention is to provide a modification method of direct electrochemical oxidation for a cell stack comprising a plurality of single cells.

To achieve the above purposes, the present invention is a method of direct electrochemical oxidation for modifying carbon felts of a flow battery, comprising steps of: (a) assembling a cell stack with electrodes made of unmodified carbon felts; (b) entering prepared electrolytes into the cell stack through pumps from an anode inlet and a cathode inlet of the cell stack to be uniformly contacted with the carbon felts under a flow rate between 20 to 100 mL/min; flowing out the electrolytes from an anode outlet and a cathode outlet to be collected in electrolyte reservoirs; recycling the electrolytes to the anode inlet and the cathode inlet to be pumped into the cell stack until air in the cell stack is completely expelled; (c) connecting the electrodes, comprising an anode electrode and a cathode electrode, with an external power supply to conduct voltage under a constant voltage mode to process electrochemical redox reactions; (d) after finishing conducting voltage, entering air into the cell stack through the anode inlet and the cathode inlet of the cell stack by using the pumps under a flow rate between 20 to 100 mL/min; exhausting air through the anode outlet and the cathode outlet; completely expelling the electrolytes originally held in the cell stack to the electrolyte reservoirs; (e) replacing the electrolytes with 1 M to 3 M of a vanadyl sulfate solution and an aqueous solution of 1 M to 5 M of an inorganic acid to be entered into the cell stack through the anode inlet and the cathode inlet of the cell stack to be uniformly contacted with the carbon felts under a flow rate between 20 to 100 mL/min; after flowing out the electrolytes through the anode outlet and the cathode outlet to be collected to the electrolyte reservoirs, recycling the electrolytes to the anode inlet and the cathode inlet of the cell stack to be pumped into the cell stack until air in the cell stack is completely expelled; (f) connecting the anode electrode and the cathode electrode with the external power supply to conduct a current between 40 milli-amperes per square centimeter (mA/cm²) and 80 mA/cm² under a constant current mode to process charge and discharge reactions in the cell stack of a flow battery; and repeating charging and discharging until completely charging the cell stack. Accordingly, a novel method of direct electrochemical oxidation for modifying carbon felts of a flow battery is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the flow view showing the preferred embodiment according to the present invention;

FIG. 2 is the structural view showing the cell stack;

FIG. 3 is the structural view showing the flow battery; and

FIG. 4 is the flow view of the general electrochemical oxidation.

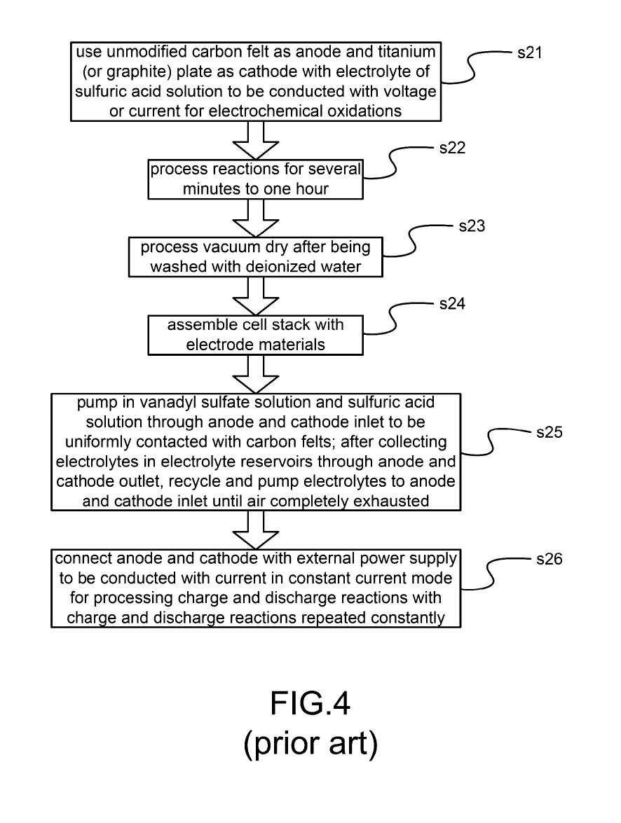

### DESCRIPTION OF THE PREFERRED EMBODIMENT

The following description of the preferred embodiment is provided to understand the features and the structures of the present invention.

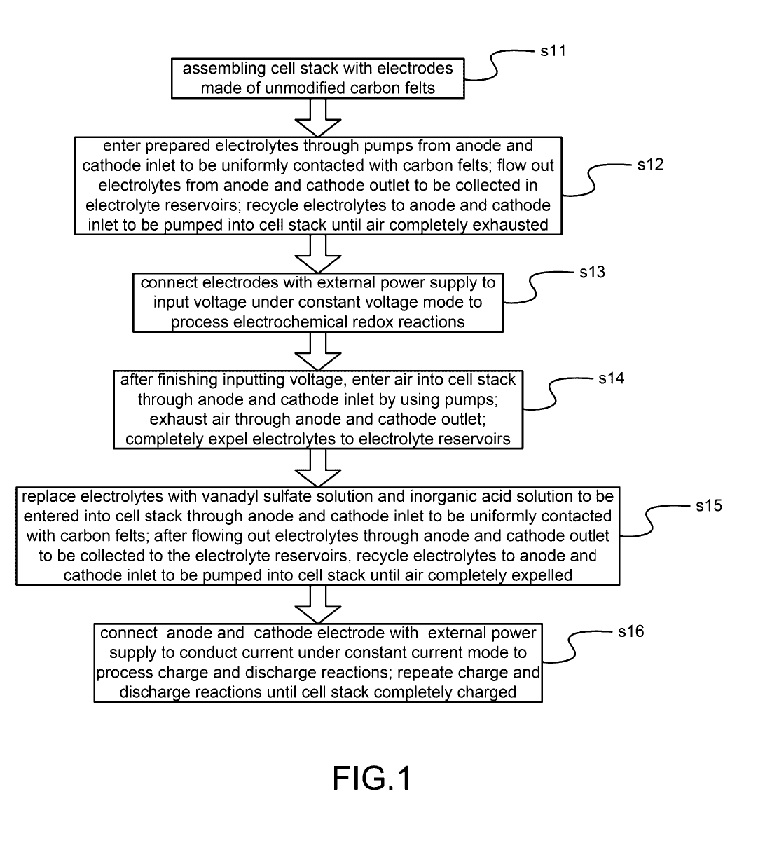

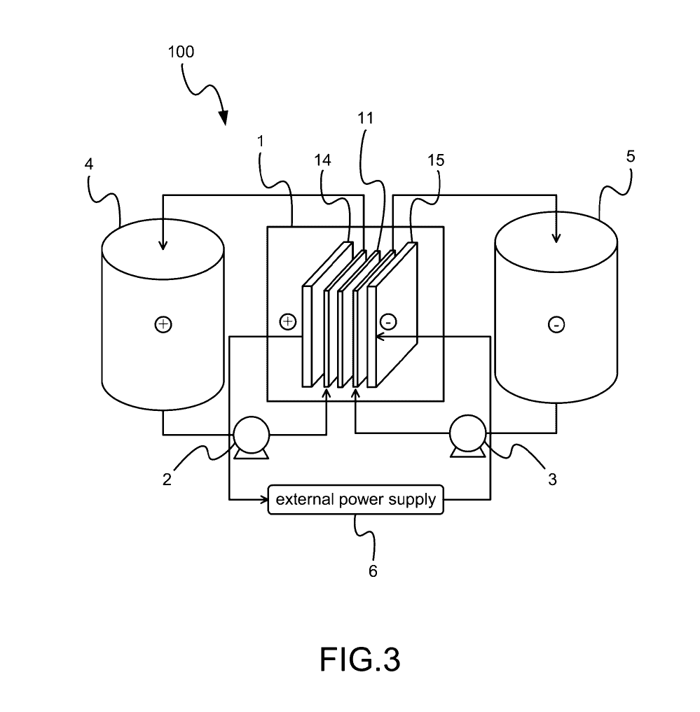

Please refer to FIG. 1-FIG. 3, which are a flow view showing a preferred embodiment according to the present invention; a structural view showing the cell stack; and a structural view showing the flow battery. As shown in the figures, the present invention is a method of direct electrochemical oxidation for modifying carbon felts of a flow battery, comprising the following steps:

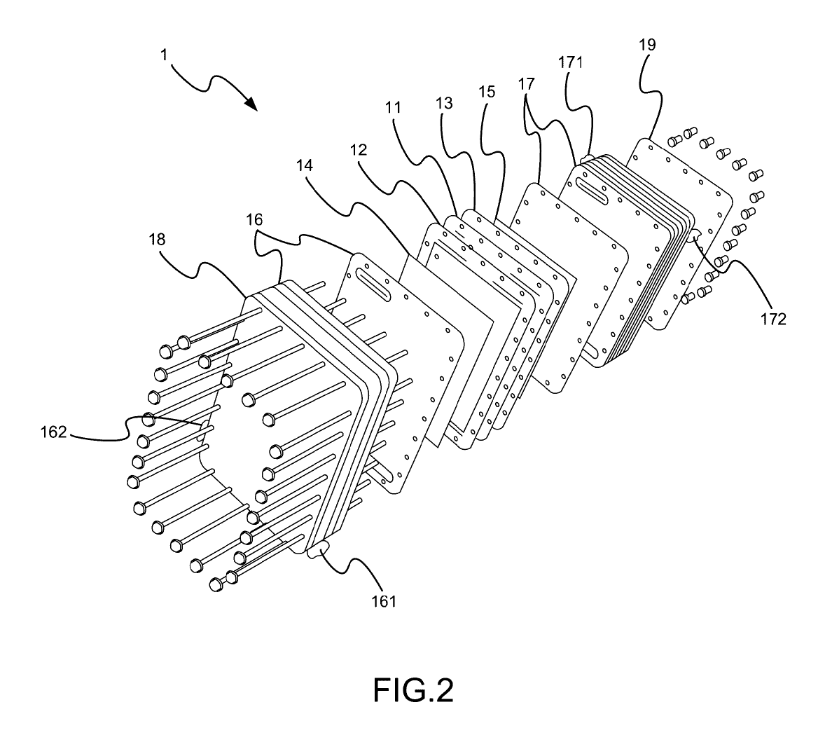

(a) Step s11: In FIG. 2, a cell stack 1 is assembled with electrodes 14, 15 made of unmodified carbon felts, where the cell stack 1 comprises a separation film 11; two gaskets 12, 13 sandwiching the separation film 11; the two electrodes 14, 15 sandwiching the two gaskets 12, 13, which are an anode and a cathode electrode 14, 15; two flow limiting plates 16, 17 sandwiching the two electrodes 14, 15, where one of the flow limiting plates 16 has an anode inlet 162 and a cathode inlet 161 and the other one of the flow limiting plates 17 has an anode outlet 172 and a cathode outlet 171; and two end plates 18, 19 sandwiching the two flow limiting plates 16, 17.

(b) Step s12: Prepared electrolytes are entered by using pumps 2, 3 from an anode and a cathode inlet 161, 162 of the cell stack 1 to be uniformly contacted with the carbon felts (i.e. the anode and the cathode electrode 14, 15) under a flow rate between 20 to 100 milli-liters per minute (mL/min). The electrolytes flow out to be collected in electrolyte reservoirs 4, 5 from an anode and a cathode outlet 171, 172. Then, the electrolytes are recycled to the anode and the cathode inlet 161, 162 to be pumped into the cell stack 1 until air in the cell stack 1 is completely exhausted. Therein, the electrolytes are selected from 0.1 M to 5 M of sulfuric acid, 0.1 M to 5 M of hydrochloric acid, 0.1 M to 5 M of nitric acid and 0.1 M to 5 M of phosphoric acid.

(c) Step s13: The anode and the cathode electrode 14, 15 is connected with an external power supply 6 to conduct a voltage between 1.5 volts per cell (V/cell) and 2.5V/cell under a constant voltage mode for processing electrochemical redox reactions, where the voltage is conducted for 5 to 20 minutes under a temperature between 20 Celsius degrees (° C.) and 30° C.

(d) Step s14: After finishing conducting voltage, air enters into the cell stack 1 through the anode and the cathode inlet 161, 162 by using the pumps 2, 3 under a flow rate between 20 and 100 mL/min. Then, air is exhausted through the anode and the cathode outlet 171, 172 and the electrolytes originally held in the cell stack 1 are completely expelled to the electrolyte reservoirs 4, 5.

(e) Step s15: The electrolytes are replaced with an aqueous solution of 1 M to 3 M of vanadyl sulfate and an aqueous solution of 1 M to 5 M of an inorganic acid and enter into the cell stack 1 through the anode and the cathode inlet 161, 162 to be uniformly contacted with the carbon felts (i.e. the two electrodes 14, 15) under a flow rate between 20 to 100 mL/min. After flowing out the electrolytes through the anode and the cathode outlet 171, 172 to be collected in the electrolyte reservoirs 4, 5, the electrolytes are recycled to the anode and the cathode inlet 161, 162 to be pumped into the cell stack 1 until air in the cell stack 1 is completely exhausted. Therein, the inorganic acid is sulfuric acid, hydrochloric acid, nitric acid or phosphoric acid.

(f) Step s16: The anode and the cathode electrode 14, 15 is connected with the external power supply 6 to conduct a current between 40 milli-amperes per square centimeter (mA/cm²) and 80 mA/cm² under a constant current mode for processing charge and discharge reactions in the cell stack 1 of a flow battery 100. The charge and discharge reactions are repeated until the cell stack 1 is completely charged.

Thus, a novel method of direct electrochemical oxidation for modifying carbon felts of a flow battery is obtained.

On using, the present invention uses electrodes made of GFD2.5 carbon felts and a separation film made of Nafion 117 for processing modification through direct electrochemical oxidation. A voltage of 2V/cell is conducted in a constant voltage mode under an operating temperature of 25° C. to process electrochemical redox reactions for 5, 10 and 20 minutes for modifying the carbon felts. Then, single cells with the carbon felts modified through the electrochemical redox reactions are obtained for charge and discharge tests. The tests are run with industrial-grade vanadyl sulfates as electrolytes at a flow rate of 50 mL/min under a temperature of 25° C. and a current density of 40 mA/cm². Test results of the single cells having the carbon felts modified through the electrochemical redox reactions are shown in Table 1, where efficiencies of the batteries are significantly increased after the direct electrochemical oxidation according to the present invention. Therein, the test which uses 5 minutes for the electrochemical redox reactions obtains the best Coulomb efficiency, energy efficiency and voltage efficiency.

TABLE I

| | | | Coulomb | energy | voltage |
|---|---|---|---|---|---|
| | Time | Voltage | efficiency | efficiency | efficiency |
| unmodified | | | 90.36 | 58.67 | 64.93 |
| carbon felts | | | | | |
| direct | 5 min | 2 V | 91.14 | 66.07 | 72.49 |
| electrochemical | | | | | |
| oxidation | | | | | |
| direct | 10 min | 2 V | 90.71 | 65.02 | 71.69 |
| electrochemical | | | | | |
| oxidation | | | | | |
| direct | 20 min | 2 V | 91.14 | 65.18 | 71.52 |
| electrochemical | | | | | |
| oxidation | | | | | |

Hence, the present invention directly conducts voltage to process redox reactions in a cell stack with carbon felts uniformly contacted with electrolytes to generate oxygen-containing functional groups (—COON, —OH) on surfaces of the carbon felts modified through direct electrochemical oxidation. Thus, the present invention has a simple and fast operation with easily regulated and replaced experimental parameters and conditions without re-dismantling a device used for the modification; the device used can sustain a wide range of voltage and current; and modification effect can be obtained with low cost yet without high-temperature treatment.

To sum up, the present invention is a method of direct electrochemical oxidation for modifying carbon felts of a flow battery, where voltage is directly conducted to process redox reactions in a cell stack with carbon felts uniformly contacted with electrolytes to generate oxygen-containing functional groups (—COOH, —OH) on surfaces of the carbon felts modified through direct electrochemical oxidation; the present invention has a simple and fast operation with easily regulated and replaced experimental parameters and conditions without re-dismantling a device used for the modification; the device used can sustain a wide range of voltage and current; and modification effect can be obtained with low cost yet without high-temperature treatment.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of direct electrochemical oxidation for modifying carbon felts of a flow battery, comprising steps of:
(a) assembling a cell stack with electrodes made of unmodified carbon felts;
(b) entering prepared electrolytes into said cell stack through pumps from an anode inlet and a cathode inlet of said cell stack to be uniformly contacted with said carbon felts under a flow rate between 20 to 100 milli-liters per minute (mL/min); flowing out said electrolytes from an anode outlet and a cathode outlet to be collected in electrolyte reservoirs; recycling said electrolytes to said anode inlet and said cathode inlet to be pumped into said cell stack until air in said cell stack is completely exhausted;
(c) connecting said electrodes, which comprises an anode electrode and a cathode electrode, with an external power supply to conduct voltage under a constant voltage mode to process electrochemical redox reactions;
(d) after finishing conducting voltage, entering air into said cell stack through said anode inlet and said cathode inlet of said cell stack by using said pumps under a flow rate between 20 to 100 mL/min; exhausting air through said anode outlet and said cathode outlet; completely expelling said electrolytes originally held in said cell stack to said electrolyte reservoirs;
(e) replacing said electrolytes with an aqueous solution of 1 M to 3 M of vanadyl sulfate and an aqueous solution of 1 M to 5 M of an inorganic acid to be entered into said cell stack through said anode inlet and said cathode inlet of said cell stack to be uniformly contacted with said carbon felts under a flow rate between 20 to 100 mL/min; after flowing out said electrolytes through said anode outlet and said cathode outlet to be collected to said electrolyte reservoirs, recycling said electrolytes to said anode inlet and said cathode inlet of said cell stack to be pumped into said cell stack until air in said cell stack is completely exhausted; and
(f) connecting said anode electrode and said cathode electrode with said external power supply to conduct a current between 40 milli-amperes per square centimeter (mA/cm²) and 80 mA/cm² under a constant current mode to process charge and discharge reactions in said cell stack of a flow battery; and repeating said charge and discharge reactions until said cell stack is completely charged.

2. The method according to claim 1,
wherein, in step (a), said cell stack comprises a separation film;
two gaskets, said gaskets sandwiching said separation film;
two electrodes, said electrodes sandwiching said two gaskets, said electrodes being an anode electrode and a cathode electrode, said electrodes being made of unmodified carbon felts;
two flow limiting plates, said flow limiting plates sandwiching said electrodes, one of said flow limiting plates having an anode inlet and a cathode inlet, the other one of said flow limiting plates having an anode outlet and a cathode outlet; and
two end plates, said end plates sandwiching said flow limiting plates.

3. The method according to claim 1,
wherein, in step (b), said electrolytes are selected from a group consist of 0.1 mole (M) to 5 M of sulfuric acid, 0.1 M to 5 M of hydrochloric acid, 0.1 M to 5 M of nitric acid and 0.1 M to 5 M of phosphoric acid.

4. The method according to claim 1,
wherein, in step (c), said voltage conducted is a voltage between 1.5 volts per cell (V/cell) and 2.5V/cell.

5. The method according to claim 1,
wherein, in step (c), said voltage is conducted for 5 to 20 minutes.

6. The method according to claim 1,
wherein, in step (c), said voltage is conducted at an operating temperature between 20 Celsius degrees (° C.) and 30° C.

7. The method according to claim 1,
wherein, in step (e), said inorganic acid is selected from a group consist of sulfuric acid, hydrochloric acid, nitric acid and phosphoric acid.

8. The method according to claim 1,
wherein said cell stack is obtained by assembling a plurality of single cells.
